(19) United States
(12) Patent Application Publication
(10) Pub. No.: US 2025/0241313 A1
(43) Pub. Date: Jul. 31, 2025

(54) APPLICATION OF ACTIVE SUBSTANCE IN IMPROVING SEED VIGOR AND METHOD FOR IMPROVING SEED VIGOR

(71) Applicant: HUNAN HYBRID RICE RESEARCH CENTER, Changsha City (CN)

(72) Inventors: Mingdong ZHU, Changsha City (CN); Yinghong YU, Changsha City (CN); Meng ZHANG, Changsha City (CN); Ruifeng KAN, Changsha City (CN); Hongjun XIE, Changsha City (CN); Yan XIAO, Changsha City (CN); Yaying YU, Changsha City (CN); Yonghong DUAN, Changsha City (CN); Xiao TANG, Changsha City (CN)

(73) Assignee: HUNAN HYBRID RICE RESEARCH CENTER, Changsha City (CN)

(21) Appl. No.: 19/037,407

(22) Filed: Jan. 27, 2025

(30) Foreign Application Priority Data
Jan. 26, 2024 (CN) 202410113329.2

(51) Int. Cl. A01N 57/12; A01P 21/00

(52) U.S. Cl. CPC A01N 57/12; A01P 21/00

(57) ABSTRACT

The invention relates to the technical field of crop production, and discloses application of an active substance in improving seed vigor and a method for improving seed vigor. The active substance is selected from at least one of phosphoenolpyruvate and salt compounds thereof. The active substance is applied to regulating and controlling the seed vigor of the crops, so that the problems of seed vigor loss and insufficient seed vigor in agricultural production caused by annual storage and transfer can be effectively solved, the economic loss of the crop production can be effectively reduced, and the agricultural production benefit can be improved.

### CROSS REFERENCE TO RELATED APPLICATIONS

This application claims the benefit of Chinese patent application 202410113329.2 filed Jan. 26, 2024, the contents of which are incorporated herein by reference.

### TECHNICAL FIELD

The invention relates to the technical field of crop production, in particular to application of an active substance in improving seed vigor and a method for improving seed vigor.

### BACKGROUND

Good seeds are the basis of modern agricultural development, and the functional characteristics of seed life support global agriculture. Seed vigor is a core indicator of seed sowing quality, which enables rapid and orderly emergence of seeds and the growth of normal seedlings.

The seeds vigor is directly related to the healthy development of the industry, and as a modern agricultural commodity, the seeds need to be stored and transferred for years from production to sale. Annual storage and transfer easily results in seed inactivation and loss of commercial value. In china, about one third of the commercial seeds are resold or discarded each year due to storage deactivation, resulting in billions of direct economic losses.

The rate of seed vigor loss is also related to the storage environment. The low temperature and dry environment can prolong the storage time of the seeds, and the high temperature and humid environment can easily inactivate the seeds. In early studies, it was recognized that regulation of seed vigor is a very complex biological process. Cytochrome-related metabolism, amino acid metabolism, detoxification pathways, and other metabolic pathways have been found to be associated with seed vigor. However, due to its complex mechanism, the key pathway for seed vigor regulation has not been fully demonstrated.

Therefore, a method for improving the vigor of stored seeds and solving the problem of insufficient seeds vigor in agricultural production is developed, scientific basis can be provided for improving the quality of crop seeds, and the method has important practical significance.

### SUMMARY OF THE INVENTION

The invention aims to solve the problems of low vigor and easy inactivation in the storage process of seeds in seed agricultural production in the prior art.

In order to achieve the above aims, the first aspect of the invention provides a use of an active substance selected from at least one of phosphoenolpyruvate and salt compound thereof for improving seed vigor.

The second aspect of the invention provides a method of improving seed vigor, the method comprising: carrying out contact treatment on seeds to be germinated and active substances;
the active substance is the active substance described in the application of the first aspect.

Compared with the prior art, the invention at least has the following advantages and beneficial effects:
the active substance is at least one selected from phosphoenolpyruvate and salt compounds thereof, and the active substance is applied to improving the seed vigor, so that the seed vigor can be remarkably improved, the problems of insufficient seed vigor and seed vigor loss caused by annual storage and transfer in agricultural production are effectively improved, the economic loss of the crop production is effectively reduced, and the agricultural production benefit is improved.

### BRIEF DESCRIPTION OF DRAWINGS

FIG. 1 is a graph showing the overall germination effects of 3 groups of rice seeds in the presence of water and PEP respectively on day 7 in example 1 of the invention;

FIG. 2 is a graph showing the individual germination effects of 3 groups of rice seeds in the presence of water and PEP respectively in example 1 of the invention;

FIG. 3 is a graph showing the individual germination state of 3 groups of rice seeds in the presence of water and PEP respectively on day 4 in example 1 of the invention;

FIG. 4 is a graph showing the overall germination effect of 3 groups of wheat seeds in the presence of water and PEP respectively on day 7 in example 2 of the invention;

FIG. 5 is a graph showing the individual germination effects of 3 groups of wheat seeds in the presence of water and PEP respectively on day 7 in example 2 of the invention;

FIG. 6 is a graph showing the overall germination effect of 3 groups of corn seeds in the presence of water and PEP respectively on day 7 in example 3 of the invention;

FIG. 7 is a graph showing the individual germination effects of 3 groups of corn seeds in the presence of water and PEP respectively on day 7 in example 3 of the invention;

FIG. 8 is a graph showing the overall germination effects of 3 groups of tomato seeds in the presence of water and PEP respectively on day 7 in example 4 of the invention;

FIG. 9 is a graph showing the individual germination effects of 3 groups of tobacco seeds in the presence of water and PEP respectively on day 7 in example 5 of the invention.

### DETAILED DESCRIPTION

The endpoints of the ranges and any values disclosed herein are not limited to the precise range or value, and these ranges or values should be understood to encompass values close to these ranges or values. For numerical ranges, each range between its endpoints and individual point values, and each individual point value can be combined with each other to give one or more new numerical ranges, and such numerical ranges should be construed as specifically disclosed herein.

In the invention, the room temperature means 25±2° C. unless contrary specified.

In the invention, “PEP” represents phosphoenolpyruvate, “PEP-K salt” represents potassium phosphoenolpyruvate, and “PEP-cyclohexylammonium salt” represents cyclohexylammonium phosphoenolpyruvate.

As previously mentioned, the first aspect of the invention provides a use of an active substance selected from at least one of phosphoenolpyruvate and salt compounds thereof for improving seed vigor.

In the invention, the performance indexes of the seed vigor comprise the germination rate, the germination potential and the germination index of the seeds.

In the invention, the evaluation standards of the seed vigor are national standards (GB 4404.1-2008), national standards (GB 4404.2-2010), national standards (GB 4404.3-2010), national standards (GB 4404.4-2010), national standards (GB/T 3543.1-1995), national standards (GB/T 2930.4-2017) and the like.

In the invention, the seed vigor is the sum of seed germination and emergence rate, seedling growth potential, plant stress resistance and production potential, and is an important index of seed quality.

The improvement of the seed vigor in the invention is to promote the seed germination vigor, and mainly improve the seed germination rate, germination potential and germination index.

Preferably, the active substance is selected from at least one of phosphoenolpyruvate, potassium phosphoenolpyruvate and cyclohexylammonium phosphoenolpyruvate.

Preferably, the active substance is present in the form of an aqueous solution, the concentration of the active substance in the aqueous solution is 0.1-1.0 mM. The inventors has surprisingly found that, in this preferred case, vigor indicators such as the germination rate, germination potential, and germination index of the seeds can be more significantly improved.

According to a particularly preferred embodiment of the invention, the concentration of the active substance in the aqueous solution is 0.2-0.5 mM. The inventor finds that the specific implementation mode under the optimal condition can obviously accelerate the root growth of the seeds and improve the number of single roots; in particular, the growth of rice seeds in leaf age can be accelerated.

As previously mentioned, a second aspect of the invention provides a method of improving seed vigor, the method comprising: carrying out contact treatment on seeds to be germinated and active substances;
the active substance is the active substance described in the application of the first aspect.

Preferably, the contact treatment mode is seed soaking treatment and/or seed dressing treatment.

Preferably, the seed soaking treatment time is 12-36 h.

Preferably, the method further comprises: carrying out germination accelerating treatment on the pretreated seeds obtained after the contact treatment.

Preferably, the operation of pregermination treatment comprises: placing the pretreated seeds in an incubator for dark culture and light culture.

According to a particularly preferred embodiment of the invention, the pregermination is carried out by placing the pretreated seeds on a germination bed in a laboratory, the pregermination being carried out by operations comprising; and (3) placing the pretreated seeds in an incubator for dark culture and light culture.

The invention has no special requirements on the types of the germination bed, and any germination bed known in the prior art can be adopted as long as the culture requirements of the invention can be met, and the germination bed can be a plant seed culture box (hereinafter referred to as a “culture box”) for example; in order to facilitate statistics of seed viability data, the plant seed culture box is an shape with small holes.

The invention has no special requirements on the types of the incubator, and any incubator known in the prior art may be used.

According to a particularly preferred embodiment of the invention, the conditions of the dark culture comprise at least: the temperature is 23-32° C., the time is 6-18 h, and the relative humidity is 40-70%.

According to a particularly preferred embodiment of the invention, the conditions of the light culture comprise at least: the illumination intensity is 10000-15000Lux, the temperature is 23-32° C., the time is 6-18 h, and the relative humidity is 40-70%.

Preferably, the pre-treated seeds are placed in a field for the pregermination treatment.

According to a particularly preferred embodiment of the invention, the pre-treated seeds are placed in a field for the pregermination treatment in an outdoor environment.

Preferably, the seeds to be germinated are selected from food crops and/or cash crops.

Preferably, the seed to be germinated is selected from at least one of rice seed, wheat seed, corn seed, soybean seed, rape seed, arabidopsis seed, tomato seed, tobacco seed, capsicum seed, cucumber seed, eggplant seed, and cotton seed.

More preferably, the seed to be germinated is selected from at least one of rice seed, wheat seed, corn seed, tomato seed and tobacco seed.

The invention will be described in detail below by way of examples.

In the following examples, unless contrary specified, all of the materials and equipment are commercially available.

PEP: CAS No. 138-08-9, purchased from Guangzhou Huayun Biotechnology, Inc., and sold under the brand Fluorochem., and having a product number of F603087.

PEP-K salt: CAS No. 4265-07-0, purchased from Guangzhou Huayun Biotechnology, Inc., and sold under the brand Sigma-Aldrich, and having a product number of 860077.

PEP-cyclohexylammonium salt: CAS No. 10526-80-4, purchased from Guangzhou Huayun Biotechnology, Inc., and sold under the brand Sigma-Aldrich, and having a product number P3637.

Rice: derived from a germplasm resource bank of crops in Hunan province, and has the variety of indica rice-Jiu Lianghuazhan ( [symbol] ),national audit rice ( [symbol] ) No. 20180117.

Wheat: derived from a germplasm resource bank of crops in Hunan province, and has the variety of Jimai 20 ( [symbol] 20) and Shannon's reference ( [symbol] ) No. [2003] 029.

Corn: derived from a germplasm resource bank of crops in Hunan province,, and has the variety of Zhengdan 958 ( [symbol] 958) and national audit jade ( [symbol] ) No. 20000009.

Tomato: derived from a germplasm resource bank of crops in Hunan province, and has the variety is PtoR (a common scientific research material).

Tobacco: derived from a germplasm resource bank of crops in Hunan province, Benshi tobacco ( [symbol] ) (a common scientific research material).

An incubator: the plant culture box is a large-capacity plant culture box which is purchased from Guangzhou Huayun Biotechnology Co., Ltd, is a brand of Shanghai-Yiheng scientific instruments Co., Ltd and has the model of MGC-350 BP.

A culture box: purchased from Guangzhou Huayun Biotechnology, Inc., under the brand name of NEST, has the model of 50 holes culture plates.

In the following examples, the relative activity index is calculated by the following formula:
(1) average germination rate: ×100% (total number of germinated seeds/total number of tested seeds within 7 days);
(2) average germination potential: ×100% (total number of germinated seeds/total number of tested seeds in the first 5 days);
(3) average germination index: Σ(number of sprouts per day/number of sprouts);
(4) statistical P-value: generally, X represents the statistical quantity of the test, and when H0 is true, the value C of the statistical quantity can be calculated from the sample data, and the P value can be obtained from the specific distribution of the test statistical quantity X. Specifically, the P value of the left test is the probability that the test statistic X is smaller than the sample statistic C, i.e.: P=P {X<C} the P value for the right-side test is the probability that the test statistic X is greater than the sample statistic C: P=P {X>C} the P value of the two-sided test is 2 times the probability that the test statistic X falls within the tail region where the sample statistic C is an endpoint: P=2P {X>C} (when C is located at the right end of the distribution curve) or P=2P {X<C} (when C is located at the left end of the distribution curve) if X obeys a normal distribution and a t-distribution, the distribution curve is symmetric about the vertical axis, so its P value can be represented as P=P {|X|>C};
after the P-value has been calculated, a test can be concluded by comparing a given significance level a to the P-value: rejecting the original hypothesis if a>P value; if a≤P value, the original assumption is accepted at significance level a. Statistics the P values obtained by the significance test method generally show that P<0.05 denotes statistically difference, P<0.01 denotes prominent statistically difference, and P<0.001 denotes extremely prominent statistically difference.

### Example 1: Application of PEP, PEP-K Salt and PEP-Cyclohexylammonium Salt in Regulation and Control of Rice Seed Vigor

The method for improving the seed vigor comprises the following steps:
(1) randomly selecting 600 rice seeds to be germinated, and dividing each group into 4 groups according to 150 rice seeds, wherein the groups are respectively called as seed-1, seed-2, seed-3 and seed-4;
(2) preparing an active substance and water at room temperature;
the specific operation is as follows: preparing three groups of PEP aqueous solution with the concentration of 0.3 mM and the volume of 500 mL; three groups of PEP-K salt aqueous solution with the concentration of 0.3 mM and the volume of 500 mL; three groups of PEP-cyclohexylammonium salt aqueous solution with the concentration of 0.3 mM and the volume of 500 mL; three groups of water with the volume of 500 mL;
(3) according to the requirements of the national standard (GB 4404.1-2008), seed-1, seed-2, seed-3 and seed-4 are respectively soaked with PEP aqueous solution, PEP-K salt aqueous solution, PEP-cyclohexylammonium salt aqueous solution and water for 24 hours;
the specific operation is as follows: averagely dividing the seed-1 into three parts and respectively scattering the three parts into three groups of PEP aqueous solution, averagely dividing the seed-2 into three parts and scattering the three parts into three groups of PEP-K salt aqueous solution, averagely dividing the seed-3 into three parts and scattering the three parts into three groups of PEP-cyclohexylammonium salt aqueous solution, and averagely dividing the seed-4 into three parts and scattering the three parts into three groups of water;
(3) placing the seeds subjected to seed soaking treatment in a culture box, and placing the culture box in an incubator to perform dark culture (the temperature is 30° C., the time is 14 h, and the relative humidity is 60%) and light culture (the illumination intensity is 12000Lux, the temperature is 30° C., the time is 10 h, and the relative humidity is 60%) in sequence;
(4) counting the number of germinated seeds every day for seeds respectively added with PEP, PEP-K salt and PEP-cyclohexylammonium salt, respectively calculating the average germination rate of 3 groups of parallel experiments within 7 days, the average germination potential of the previous 5 days and the average germination index of the previous 5 days, and calculating respective statistical P values.

Specific results are shown in table 1.

TABLE 1

| | Average | average | Average |
|---|---|---|---|
| | germination | germination | germination |
| | rate | potential | index |
| Water | 54% | 48% | 7.71 |
| PEP | 72% | 66% | 11.04 |
| P value-PEP | ** 0.000785 | ** 0.000394 | ** 0.00015 |
| PEP-K salt | 68% | 64% | 10.76 |
| P value- (PEP-K salt) | ** 0.000953 | ** 0.000682 | ** 0.00054 |
| PEP- | 70% | 66% | 10.82 |
| cyclohexylammonium | | | |
| salt | | | |
| P value- (PEP- | ** 0.000841 | ** 0.000549 | ** 0.00037 |
| cyclohexylammonium | | | |
| salt) | | | |

Note:
“*” denotes prominent statistically difference,
“**” denotes extremely prominent statistically difference.

### Example 2: Application of PEP, PEP-K Salt and PEP-Cyclohexylammonium Salt in Regulation and Control of Wheat Seed Vigor

This example was carried out in the similar manner as in example 1, except that in this example, wheat seeds were used in place of the rice seeds in example 1, and the other steps were the same as in example 1.

The specific results are shown in table 2.

TABLE 2

| | Average | average | Average |
|---|---|---|---|
| Water | 14% | 14% | 2.75 |
| PEP | 24% | 24% | 6.366667 |
| P value-PEP | * 0.003773 | 0.011739 | * 0.003207 |
| PEP-K salt | 22% | 21% | 6.333333 |
| P value- (PEP-K salt) | * 0.005235 | 0.013872 | * 0.005518 |
| PEP-cyclohexylammonium salt | 21% | 19% | 5.066667 |
| P value- (PEP- | * 0.007841 | 0.032189 | * 0.006337 |
| cyclohexylammonium salt) | | | |

Note:
“*” denotes prominent statistically difference,
“**” denotes extremely prominent statistically difference.

### Example 3: Application of PEP, PEP-K Salt and PEP-Cyclohexylammonium Salt in Regulation and Control of Corn Seed Vigor

This example was carried out in the similar manner as in example 1, except that in this example, corn seeds were used in place of the rice seeds in example 1, and the other steps were the same as in example 1.

The specific results are shown in table 3.

TABLE 3

| | Average | average | Average |
|---|---|---|---|
| | germination | germination | germination |
| | rate | potential | index |
| Water | 32% | 32% | 5.783333 |
| PEP | 68% | 70% | 14.2 |
| P value-PEP | * 0.003975 | * 0.002467 | * 0.002916 |
| PEP-K salt | 68% | 70% | 14.5 |
| P value- (PEP-K salt) | * 0.004891 | * 0.002850 | * 0.005287 |
| PEP-cyclohexylammonium | 58% | 60% | 10.25 |
| salt | | | |
| P value- (PEP- | * 0.007553 | * 0.003241 | * 0.008104 |
| cyclohexylammonium salt) | | | |

Note:
denotes prominent, denotes extremely prominent.
Note:
“*” denotes prominent statistically difference,
“**” denotes extremely prominent statistically difference.

### Example 4: Application of PEP, PEP-K Salt and PEP-Cyclohexylammonium Salt in Regulation and Control of Tomato Seed Vigor

This example was carried out in the similar manner as in example 1, except that in this example, tomato seeds were used in place of the rice seeds in example 1, and the other steps were the same as in example 1.

The specific results are shown in table 4.

TABLE 4

| | Average | average | Average |
|---|---|---|---|
| | germination | germination | germination |
| | rate | potential | index |
| Water | 41% | 38% | 6.3333 |
| PEP | 60% | 59% | 9.783333 |
| P value-PEP | * 0.005952 | * 0.005210 | * 0.007679 |
| PEP-K salts | 65% | 64% | 10.73333 |
| P value- (PEP-K salt) | * 0.004863 | * 0.003208 | ** 0.001722 |
| PEP-cyclohexylammonium | 66% | 65% | 10.23333 |
| salt | | | |
| P value- (PEP- | * 0.001049 | * 0.001400 | ** 0.000599 |
| cyclohexylammonium salt) | | | |

Note:
“*” denotes prominent statistically difference,
“**” denotes extremely prominent statistically difference.

### Example 5: Application of PEP, PEP-K Salt and PEP-Cyclohexylammonium Salt in Regulation and Control of Tobacco Seed Vigor

This example was carried out in the similar manner as in example 1, except that in this example, tobacco seeds were used in place of the rice seeds in example 1, and the other steps were the same as in example 1.

The specific results are shown in table 5.

TABLE 5

| | Average | average | Average |
|---|---|---|---|
| | germination | germination | germination |
| | rate | potential | index |
| Water | 50% | 48% | 7.6333 |
| PEP | 70% | 64% | 12.78333 |
| P value-PEP | ** 0.000766 | * 0.004479 | * 0.003073 |
| PEP-K salt | 66% | 64% | 11.83333 |
| P value- (PEP-K salt) | * 0.001193 | * 0.009697 | * 0.007343 |
| PEP-cyclohexylammonium | 68% | 65% | 10.53333 |
| salt | | | |
| P value- (PEP- | * 0.008902 | * 0.007354 | * 0.004627 |
| cyclohexylammonium salt) | | | |

Note:
“*” denotes prominent statistically difference,
“**” denotes extremely prominent statistically difference.

### Example 6: Application of Active Substances with Different Concentrations in Regulation and Control of Rice Seed Vigor

This example was carried out in the similar manner as in example 1, except that in this example, 0.09 mM aqueous PEP solution, 0.2 mM PEP aqueous solution, 0.5 mM PEP-K salt aqueous solution and 1.1 mM PEP-cyclohexylammonium salt aqueous solution were used as active substance, respectively, and the other steps were the same as in example 1.

The specific results are shown in table 6.

TABLE 6

| | Average | average | Average |
|---|---|---|---|
| | germination | germination | germination |
| | rate | potential | index |
| Water | 54% | 48% | 7.71 |
| 0.09 mM PEP | 63% | 61% | 8.43 |
| P value- 0.09 mM PEP | 0.07583 | * 0.01703 | 0.08435 |
| 0.2 mM PEP | 72% | 66% | 11.04 |
| P value-0.2 mM PEP | ** 0.000785 | ** 0.000394 | ** 0.00015 |
| 0.5 mM PEP-K salt | 68% | 64% | 10.76 |
| P value- (PEP-K salt) | ** 0.000499 | ** 0.000768 | ** 0.000709 |
| 1.1 mM PEP- | 62% | 64% | 9.82 |
| cyclohexylammonium salt | | | |
| P value- (PEP- | 0.039878 | 0.088613 | 0.041137 |
| cyclohexylammonium salt) | | | |

Note:
“*” denotes prominent statistically difference,
“**” denotes extremely prominent statistically difference.

The results in the table show that the PEP, the PEP-K salt and the PEP-cyclohexylammonium salt are applied to the seed germination process, so that the vigor indexes such as the germination rate, the germination potential and the germination index of the seeds can be obviously improved, and the seed germination and the root growth are promoted; particularly, the PEP-K salt and the PEP-cyclohexylammonium salt are applied to seeds stored for many years, so that the problem of seed inactivation can be effectively solved.

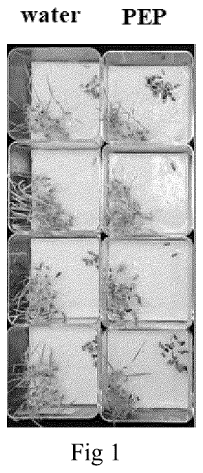

The invention exemplarily provides a graph of germination viability of rice seeds according to example 1 of the invention, a graph of germination viability of wheat seeds according to example 2 of the invention, a graph of germination viability of corn seeds according to example 3 of the invention, a graph of germination viability of tomato seeds according to example 4 of the invention, and a graph of germination viability of tobacco seeds according to example 5 of the invention, respectively shown in FIG. 1-9.

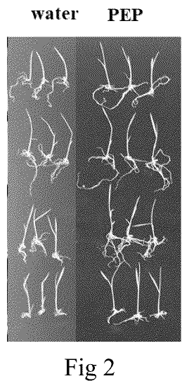

The overall germination effect and the individual germination effect of 3 groups of rice seeds in the presence of water and PEP on day 7 in example 1 are shown in FIGS. 1 and 2, respectively. Wherein, the left part of FIG. 1 represents the overall germination effect of 3 groups of rice seeds in the presence of water on day 7, and the right part of FIG. 1 represents the overall germination effect of 3 groups of rice seeds in the presence of PEP on day 7; the left part of FIG. 2 shows the individual germination effect of 3 groups rice seeds in the presence of water on day 7, and the right part of FIG. 2 shows the individual germination effect of 3 groups of rice seeds in the presence of PEP on day 7.

The individual germination state of the 3 groups of rice seeds in the presence of water and PEP respectively on day 4 in example 1 are shown in FIG. 3. Wherein, the left part of FIG. 3 represents the individual germination state of 3 groups of rice seeds in the presence of water on day 4, and the right part of FIG. 3 represents the individual germination state of 3 groups of rice seeds in the presence of PEP on day 4.

As can be seen from FIG. 1, FIG. 2 and FIG. 3, compared with the control group water, the addition of PEP during the germination of rice seeds can effectively improve the germination condition of rice seeds, and particularly can significantly accelerate the growth of the root system and leaf of rice seeds, and the root system of rice seeds added with PEP grows more flourished and developed within the same germination time.

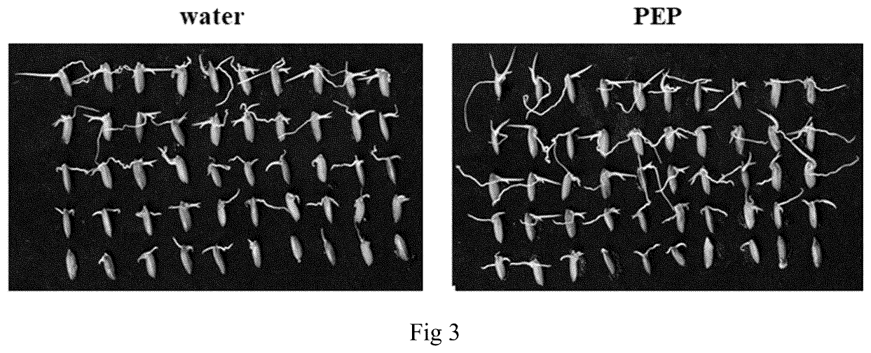

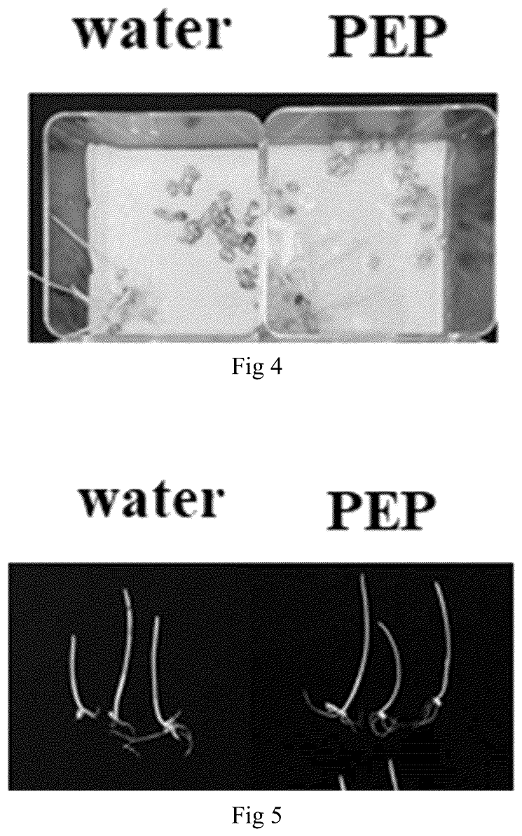

The overall germination effect and the individual germination effect of the 3 groups wheat seeds in the presence of water and PEP respectively on day 7 in example 2 are shown in FIGS. 4 and 5. Wherein, the left part of FIG. 4 represents the overall germination effect of 3 groups of wheat seeds in the presence of water on day 7, and the right part of FIG. 4 represents the overall germination effect of 3 groups of wheat seeds in the presence of PEP on day 7; the left part of FIG. 5 shows the individual germination effect of 3 groups of wheat seeds in the presence of water on day 7, and the right part of FIG. 5 shows the individual germination effect of 3 groups of wheat seeds in the presence of PEP on day 7.

As can be seen from FIGS. 4 and 5, compared with the control group water, the PEP is added in the germination process of the wheat seeds, so that the germination condition of the wheat seeds can be effectively improved, and the root growth of the wheat seeds can be accelerated.

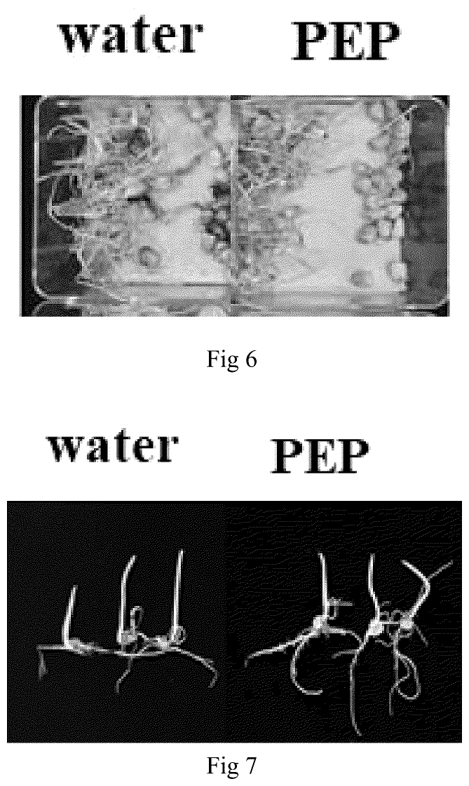

The overall germination effect and individual germination effect of 3 groups of corn seeds in the presence of water and PEP on day 7 in example 3 are shown in FIGS. 6 and 7, respectively. Wherein, the left part of FIG. 6 represents the overall germination effect of 3 groups of corn seeds in the presence of water on day 7, and the right part of FIG. 6 represents the overall germination effect of 3 groups of corn seeds in the presence of PEP on day 7; the left part of FIG. 7 shows the individual germination effect of 3 groups of corn seeds in the presence of water on day 7, and the right part of FIG. 7 shows the individual germination effect of 3 groups of corn seeds in the presence of PEP on day 7.

As can be seen from FIGS. 6 and 7, compared with the control group water, the PEP is added in the germination process of the corn seeds, so that the germination condition of the corn seeds can be effectively improved, and the root growth of the corn seeds can be accelerated.

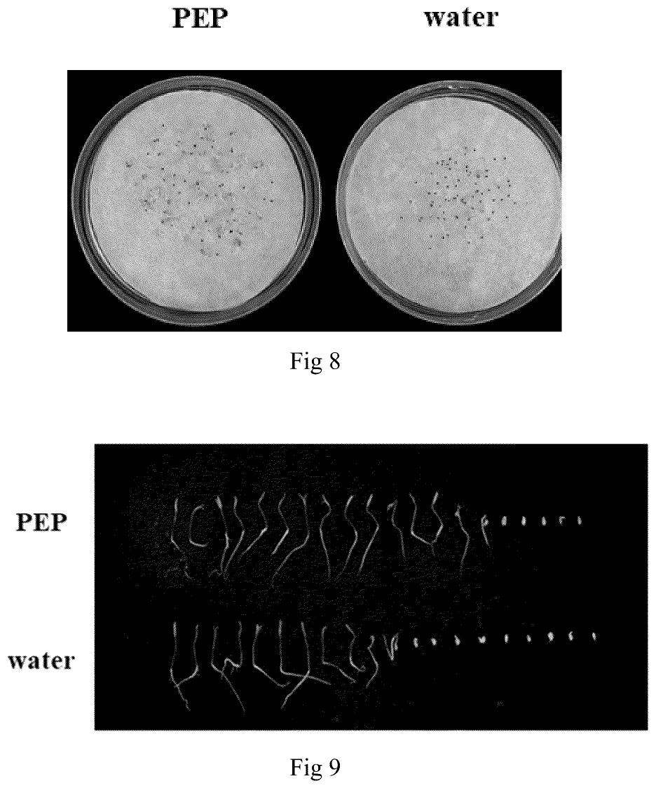

The overall germination effect of 3 groups of tomato seeds in the presence of water and PEP on day 7 inexample 4 are shown in FIG. 8. Wherein, the left part of FIG. 8 represents the overall germination effect of 3 groups of tomato seeds in the presence of PEP on day 7, and the right part of FIG. 8 represents the overall germination effect of 3 groups of tomato seeds in the presence of water on day 7.

As can be seen from the graph 8, compared with the water of the control group, the PEP is added in the tomato seed germination process, so that the germination condition of the corn seeds can be effectively improved, particularly the root system growth of the tomato seeds can be accelerated, and the root system of the tomato seeds is more flourished and developed after the PEP is added in the same germination time.

The individual germination effects of 3 groups of tobacco seeds in the presence of water and PEP respectively on day 7 in example 5 are shown in FIG. 9. Wherein, the upper part of FIG. 9 shows the individual germination effect of 3 groups of tobacco seeds in the presence of PEP on day 7, and the lower part of FIG. 9 shows the individual germination effect of 3 groups of tobacco seeds in the presence of water on day 7.

As can be seen from FIG. 9, compared with the control group of water, the PEP is added in the process of the germination of the tobacco seeds, so that the germination condition of the tobacco seeds can be effectively improved, particularly, the root system growth of the tobacco seeds can be accelerated, and the root system of the tobacco seeds is flourished and developed after the PEP is added in the same germination time.

The preferred embodiments of the invention have been described above in detail, but the invention is not limited thereto. Within the scope of the technical idea of the invention, many simple modifications can be made to the technical solution of the invention, including various technical features being combined in any other suitable way, and these simple modifications and combinations should also be regarded as the disclosure of the invention, and all fall within the scope of the invention.

1. Use of an active substance for improving the vigor of seeds, wherein the active substance is selected from at least one of phosphoenolpyruvate and salt compounds thereof.

2. The use according to claim 1, wherein the active substance is selected from at least one of phosphoenolpyruvate, potassium n phosphoenolpyruvate and cyclohexylammonium phosphoenolpyruvate.

3. The use according to claim 1, wherein the active substance is present in the form of an aqueous solution, the concentration of the active substance in the aqueous solution is 0.1-1.0 mM.

4. The use according to claim 3, wherein the concentration of the active substance in the aqueous solution is 0.2-0.5 mM.

5. A method of improving seed vigor, wherein the method comprising: carrying out contact treatment on seeds to be germinated and active substances;
the active substance is selected from at least one of phosphoenolpyruvate and salt compounds thereof.

6. The method according to claim 5, wherein the contact treatment mode is seed soaking treatment.

7. The method according to claim 5, wherein the contact treatment mode is seed dressing treatment.

8. The method according to claim 5, wherein the active substance is selected from at least one of phosphoenolpyruvate, potassium phosphoenolpyruvate and cyclohexylammonium phosphoenolpyruvate.

9. The method according to claim 5, wherein the active substance is present in the form of an aqueous solution, the concentration of the active substance in the aqueous solution is 0.1-1.0 mM.

10. The method according to claim 9, wherein the concentration of the active substance in the aqueous solution is 0.2-0.5 mM.

11. The method according to claim 5, wherein the method further comprises:
carrying out germination accelerating treatment on the pretreated seeds obtained after the contact treatment.

12. The method according to claim 11, wherein the operation of the pregermination treatment comprises: placing the pretreated seeds in an incubator for dark culture and light culture.

13. The method according to claim 12, wherein the conditions of the dark culture comprise at least: the temperature is 23-32° C., the time is 6-18 h, and the relative humidity is 40-70%.

14. The method according to claim 12, wherein the conditions of the light culture comprise at least: the illumination intensity is 10000-15000Lux, the temperature is 23-32° C., the time is 6-18 h, and the relative humidity is 40-70%.

15. The method according to claim 5, wherein the seed to be germinated is selected from at least one of rice seed, wheat seed, corn seed, soybean seed, rape seed, arabidopsis seed, tomato seed, tobacco seed, capsicum seed, cucumber seed, eggplant seed, and cotton seed.

16. The method according to claim 8, wherein the seed to be germinated is selected from at least one of rice seed, wheat seed, corn seed, soybean seed, rape seed, arabidopsis seed, tomato seed, tobacco seed, capsicum seed, cucumber seed, eggplant seed, and cotton seed.

17. The method according to claim 9, wherein the seed to be germinated is selected from at least one of rice seed, wheat seed, corn seed, soybean seed, rape seed, arabidopsis seed, tomato seed, tobacco seed, capsicum seed, cucumber seed, eggplant seed, and cotton seed.

18. The method according to claim 10, wherein the seed to be germinated is selected from at least one of rice seed, wheat seed, corn seed, soybean seed, rape seed, arabidopsis seed, tomato seed, tobacco seed, capsicum seed, cucumber seed, eggplant seed, and cotton seed.

19. The method according to claim 11, wherein the seed to be germinated is selected from at least one of rice seed, wheat seed, corn seed, soybean seed, rape seed, arabidopsis seed, tomato seed, tobacco seed, capsicum seed, cucumber seed, eggplant seed, and cotton seed.

20. The method according to claim 15, wherein the seed to be germinated is selected from at least one of rice seed, wheat seed, corn seed, tomato seed and tobacco seed.
